(19) United States
(12) Patent Application Publication
(10) Pub. No.: US 2003/0025378 A1
(43) Pub. Date: Feb. 6, 2003

(54) Turnable armrest for an office chair

(76) Inventor: Chin-Tao Lin, Taichung (TW)

Correspondence Address: Chin-Tao Lin, 58, MA YUAN WEST ST., TAICHUNG, TW

(21) Appl. No.: 09/887,988

(22) Filed: Jun. 21, 2001

(51) Int. Cl. B60N 2/46; A47C 7/54

(52) U.S. Cl. 297/411.35

(57) ABSTRACT

The present invention relates to a turnable armrest for an office chair. The armrest comprises an armrest-connecting piece, a turning piece and a fixing piece that are fixed and connected by means of connecting screws, a turning axle, a fixed turning axle and screws. It is possible to readily adjust the width of the armchair between the two armrests for everyone.

### FIELD OF THE INVENTION

The present invention relates to an improved armchair, and particularly to a turnable armrest for an office chair. The armrest comprises an armrest-connecting piece, a turning piece and a fixing piece that are sequentially connected by means of two connecting screws, a turning axle, a fixed turning axle and several screws.

### BACKGROUND OF THE INVENTION

In a commercially available armchair, the armrests generally have fixed size and are not adjustable as desired. Thus, it is impossible to vary the distance or space between the two armrests. Such an armchair will not suit and comfort everyone, especially those who are not slim enough to seat on the armchair.

Accordingly, there is a need to improve the conventionally used armchairs for better seating. The armrest should be adjustable for everyone and effectively provide comfort for people's arms resting thereon.

### SUMMARY OF THE INVENTION

The objective of the present invention is to provide a turnable armrest that can be adjustable for everyone and therefore provide better comfort for arms resting thereon.

In accordance with the present invention, the turnable armrest comprises an armrest, an armrest-connecting piece, a turning piece, a fixing piece and an armrest base that are sequentially connected by means of two connecting screws, a turning axle, a fixed turning axle and several screws. The turning piece is turnable with respect to the fixed turning axle that goes through one of the two through holes of the turning piece and the turning piece is also confined by the turning axle that is movable in the other through hole. The protrusions provided on the armrest-connecting piece are fitted into the grooves provided on the turning piece so that the armrest-connecting piece is fixed onto the turning piece. Thus, the armrest relying on the turning piece is also turnable with respect to the armrest base.

According to the present invention, it is possible to readily adjust the width of the armchair between the two armrests.

### BRIEF DESCRIPTION OF THE DRAWINGS

The above and other objectives, features and advantages of the invention will become apparent from the following detailed description of preferred embodiment in connection with the accompanying drawings in which:

FIG. 1 is an exploded view of a turnable armrest in accordance with one embodiment of the present invention.

FIG. 2 is a perspective view of a turnable armrest in accordance with one embodiment of the present invention.

FIG. 3 is a cross sectional side view of a turnable armrest in accordance with one embodiment of the present invention.

FIG. 4 is a cross sectional bottom view of a turnable armrest in accordance with one embodiment of the present invention illustrating the turning of the armrest.

It is noted that the drawings of the invention are not to scale. The drawings are merely schematic representations, not intended to portray specific parameters of the invention, rather to illustrate the principles of the invention. The drawings are intended to depict only a typical embodiment of the invention and therefore should not be considered as limiting the scope of the invention.

### REFERENCE NUMERALS OF THE ELEMENTS IN THE DRAWINGS

Reference Numerals of the Elements in the Drawings

| | |
|---|---|
| 1 | armrest |
| 2 | threaded hole |
| 3 | receiving groove |
| 4 | groove |
| 5 | through hole |
| 6 | through hole |
| 7 | armrest-connecting piece |
| 8 | connecting screw |
| 9 | protrusion |
| 10 | fixed turning axle |
| 11 | screw |
| 12 | turning piece |
| 13 | through hole for axle 10 |
| 14 | groove |
| 15 | turning axle |
| 16 | through hole for axle 15 |
| 17 | axle hole |
| 18 | pressing protrusion |
| 19 | fixing piece |
| 20 | threaded hole |
| 21 | threaded hole |
| 22 | armrest base |
| 23 | threaded hole |
| 24 | screw base |
| 25 | screw |

### DETAILED DESCRIPTION OF THE PREFERRED EMBODIMENT

A turnable armrest will be described below as a preferred embodiment of the present invention. It should be understood, however, that the present disclosure is to be considered as an exemplification of the principles of this invention and is not intended to limit the invention to the illustrated embodiment.

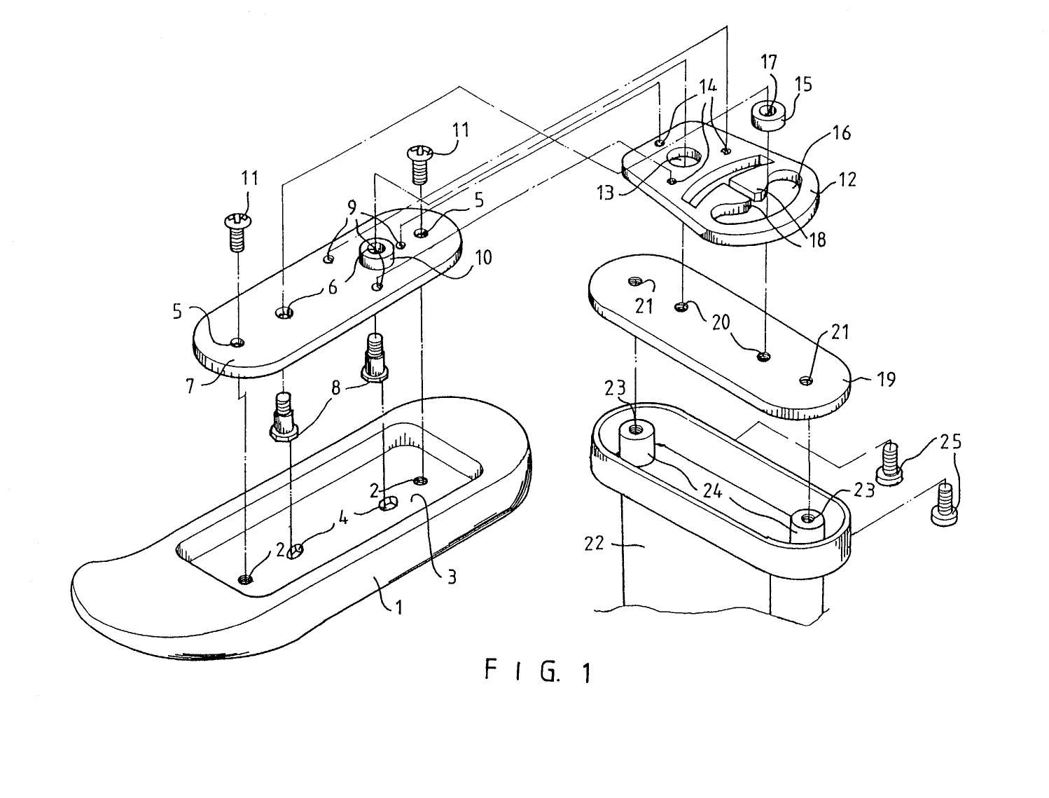

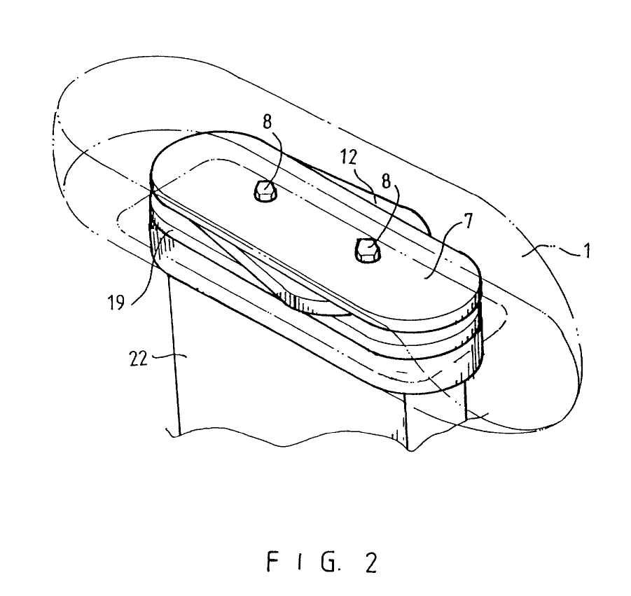

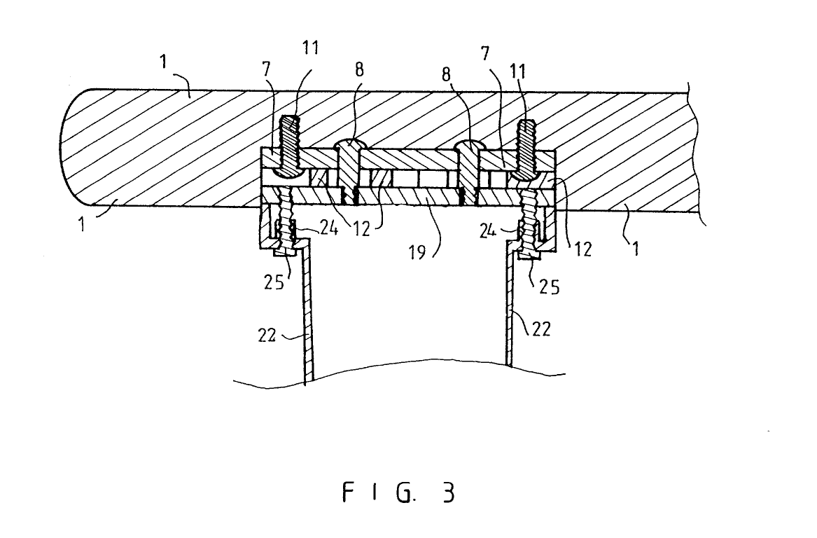

Please refer to FIGS. 1, 2 and 3, which are an exploded view, a perspective view and a cross sectional side view of a turnable armrest in accordance with the embodiment of the present invention, respectively. The turnable armrest comprises an armrest 1, an armrest-connecting piece 7, a turning piece 12, a fixing piece 19 and an armrest base 22. These components are sequentially connected and are described in details as follows.

The armrest 1 has a receiving groove 3 on its bottom surface for accommodating the armrest-connecting piece 7, the turning piece 12 and the fixing piece 19. Two threaded holes 2 are provided near the front and rear ends of the receiving groove 3, respectively, for two screws 11 in order to secure the armrest-connecting piece 7 onto the receiving groove 3 of the armrest 1. Between the two threaded holes 2 and near the center of the receiving groove 3 are provided with two grooves 4 for accommodating two connecting screws 8.

The armrest-connecting piece 7 has two through holes 5 near its front and rear ends, respectively, which correspond to the two threaded holes 2 on the receiving groove 3, so that the armrest-connecting piece 7 is secured onto the receiving groove 3 by the two screws 11. Two through holes 6 are provided on the armrest-connecting piece 7, which correspond respectively to the two grooves 4 on the receiving groove 3 of the armrest 1, so that the two connecting screws 8 will go sequentially through the two through holes 6 and the turning piece 12 and reach into the fixing piece 19. One of the through holes 6 is formed in a fixed turning axle 10 that is protruded from the bottom surface of the armrest-connecting piece 7 and that can be injection-molded integrally with the armrest-connecting piece 7. The fixed turning axle 10 will go through a through hole 13 provided on the turning piece 12. Around the fixed turning axle 10 and on the armrest-connecting piece 7 are provided with three protrusions 9 that will be fitted respectively into three grooves 14 provided on the turning piece 12.

The turning piece 12 is provided with a through hole 13 through which the fixed turning axle 10 of the armrest-connecting piece 7 go. Around the through hole 13 and on the turning piece 12 are provided with three grooves 14 that will accommodate respectively the three protrusions 9 provided on the armrest-connecting piece 7. The protrusions 9 and the grooves 14 will thus cooperatively fix the armrest-connecting piece 7 onto the turning piece 12. Near the curved end of the turning piece 12 and opposite to the through hole 13 is a through hole 16 designed for the turning of the armrest 1. In the through hole 16 are two pressing protrusions 18 that extend radially. The pressing protrusions 18 are used to stop and press a turning axle 15. The turning axle 15 is movable or slidable in the through hole 16 and has an axle hole 17 through which one of the connecting screws 8 will go.

The fixing piece 19 has two threaded holes 21 near its front and rear ends, respectively, which correspond to two threaded holes 23 on the armrest base 22, so that the fixing piece 19 is secured onto the armrest base 22 by two screws 25. Between the two threaded holes 21 are provided with two threaded holes 20, which correspond respectively to the through holes 13 and 16.

The armrest base 22 has two screw bases 24 that are provided respectively with the two threaded holes 23. The fixing piece 19 is secured to the armrest based 22 by the two screws 25 which go through the two threaded holes 23 of the armrest based 22 and into the two threaded holes 21 on the fixing piece 19. The armrest base 22 is, of course, mounted on the chair.

The connecting screws 8, both starting from the two grooves 4 of the armrest 1, cooperatively connect the armrest-connecting piece 7, the turning piece 12 and the fixing piece 19. One of the connecting screws 8 goes sequentially through the through hole 6 which is not formed in the fixed turning axle 10 of the armrest-connecting piece 7, the axle hole 17 of the turning axle 15 moving in the through hole 16 of the turning piece 12, and one of the threaded holes 20 of the fixing piece 19. The other connecting screws 8 goes sequentially through the through hole 6 which is formed in the fixed turning axle 10 of the armrest-connecting piece 7, the through hole 13 of the turning piece 12, and the other threaded hole 20 of the fixing piece 19.

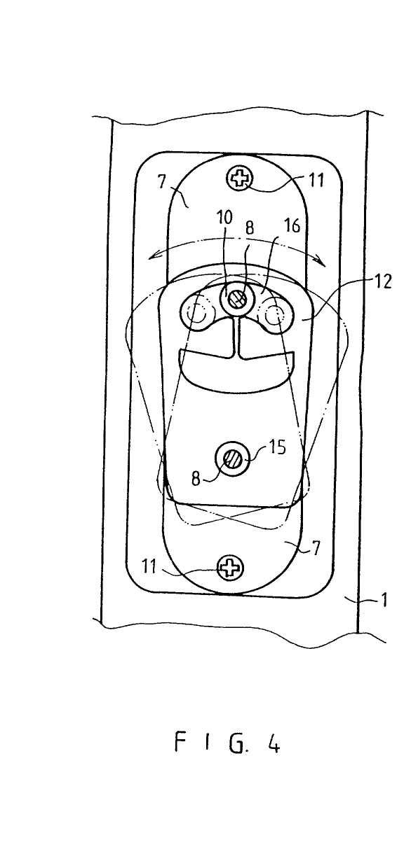

Please refer to FIG. 4, which is a cross sectional bottom view of a turnable armrest in accordance with the embodiment of the present invention illustrating the turning of the armrest. The turning piece 12 is sandwiched between the armrest-connecting piece 7 and the fixing piece 19 (not shown). The turning piece 12 is turnable with respect to the fixed turning axle 10 and is confined by the turning axle 15 moving in the through hole 16. Please note that the protrusions 9 (not shown) of the armrest-connecting piece 7 fitted into the grooves 14 (not shown) on the turning piece 12 will fix the armrest-connecting piece 7 onto the turning piece 12. Thus, the armrest I relying on the armrest-connecting piece 7 (and thus on the turning piece 12) is also turnable with respect to the fixing piece 19 (and thus to the armrest base 22). (19 and 22 are not shown.)

According to the present invention, it is possible to readily adjust the width of the armchair between the two armrests for everyone and therefore provide better comfort for people's arms resting thereon. The present invention also has the advantage of cost saving since the provision of large armchairs for some people will be unnecessary.

While the invention has been described with specific reference to the embodiment, someone skilled in the art will recognize that changes can be made in form and detail without departing from the spirit and the scope of the invention. All changes that come within the meaning and range of equivalency of the claims are to be embraced within their scope.

What is claimed is:

1. A turnable armrest for an office chair, comprising an armrest, an armrest-connecting piece, a turning piece, a fixing piece and an armrest base that are sequentially connected by means of two connecting screws, a turning axle, a fixed turning axle and several screws;
wherein the turning piece is turnable with respect to the fixed turning axle that goes through one of the two through holes of the turning piece and the turning piece is also confined by the turning axle that is movable in the other through hole;
wherein the protrusions provided on the armrest-connecting piece are fitted into the grooves provided on the turning piece so that the armrest-connecting piece is fixed onto the turning piece; and
wherein the armrest relying on the turning piece is thus turnable with respect to the armrest base so that the width of the armchair between the two armrests can be readily adjusted.
